(19) United States
(12) Patent Application Publication
(10) Pub. No.: US 2014/0049071 A1
(43) Pub. Date: Feb. 20, 2014

(54) Sound Insulation Structure

(71) Applicants: Robert E. Riedel, JR., Peoria, IL (US); Kevin Urquhart, Birtley (GB)

(72) Inventors: Robert E. Riedel, JR., Peoria, IL (US); Kevin Urquhart, Birtley (GB)

(73) Assignee: CATERPILLAR, INC., Peoria, IL (US)

(21) Appl. No.: 13/584,901

(22) Filed: Aug. 14, 2012

(51) Int. Cl. E04B 1/84; B60R 21/02; B62D 33/06; B23P 11/00

(52) U.S. Cl. 296/190.03; 181/290; 181/286; 29/428

(57) ABSTRACT

A sound insulation structure for vehicles, machines and equipment powered by internal combustion engines equipped with emission control systems designed to meet the T4i and T4 emission standards is disclosed. The disclosed sound insulation structure includes a barrier core layer disposed between two insulation layers. Each insulation layer is disposed between the barrier core layer and either a facing layer or a backing layer. The insulation layers may be fabricated from fiberglass while the barrier core layer may be fabricated from a polymer or a rubberized polymer such as rubberized polyethylene. The backing and facing layers may be fabricated from non-woven materials such as non-woven cellulose fibers. The sound insulation structure may also be fire resistant.

### BACKGROUND

1. Technical Field

This disclosure relates generally to sound insulation structures and, more specifically, to sound insulation structures for passenger compartments of vehicles, machines and/or equipment.

2. Description of the Related Art

As of 2011, mobile engines greater than 130 bkW (175 bhp) and non-emergency stationary engines less than 10 liters per cylinder and greater than 130 bkW (175 bhp) are required to meet Tier 4 Interim (T4i) emissions regulations set by the US Environmental Protection Agency. The T4i regulations not only apply to new diesel engines used in power generation, but the T4i regulations also affect industrial applications, petroleum packages, and diesel-powered construction equipment used in non-road applications.

The T4i regulations call for substantial reductions in particulate matter (PM) emissions and in NOₓ emissions, depending on the kilowatt rating of the engine or generator. T4i is the fourth phase of the non-road EPA air quality regulations since 1996 and will be followed by a further phase of regulations known as the Tier 4 Final regulations (T4) that require further emission reductions in 50^{th} NOₓ and PM in addition to the reductions required by the T4i regulations.

There are three key approaches for meeting the T4i emissions standards: selective catalytic reduction (SCR); exhaust gas recirculation (EGR); and diesel particulate filters (DPFs). SCR typically involves an injection of a urea solution known as diesel exhaust fluid (DEF) to neutralize nitrogen oxides (NOₓ) in the exhaust stream. The reaction between the urea solution and the exhaust gases takes place in a catalytic converter. EGR works by recirculating a portion of the exhaust gas back into the engine; the recirculation reduces the oxygen content and lowers the combustion temperature resulting in a reduction of NOₓ formation. DPFs remove particulate matter (PM) such as carbon soot.

Unfortunately, integration of the above emission reduction approaches may increase the noise generated by the engine. As a result, operators of diesel powered equipment may be subjected to increased noise levels. Hearing loss from exposure to noise in the work place is one of the most common of all industrial diseases. Short-term exposure to excessive noise can cause temporary hearing loss, lasting from a few seconds to a few days. Exposure to loud noises over a long period of time can cause permanent hearing loss. Hearing loss that occurs over time is not always easy to recognize and unfortunately, most workers do not realize they are going deaf until their hearing is permanently damaged. Noise exposure can be controlled by reducing the noise at the source producing it or by providing added protection for the operators. This disclosure is related to latter—providing added protection for the operators of vehicles, equipment and machines powered by loud engines or generators that may have been designed to melt the T4i and T4 emission standards.

### SUMMARY OF THE DISCLOSURE

In one aspect, a sound insulation structure is disclosed. The sound insulation structure may include a barrier core layer disposed between a first insulation layer and a second insulation layer. The first insulation layer may be disposed between the barrier core layer and a facing layer. The second insulation layer may be disposed between the barrier core layer and a backing layer.

In another aspect, a machine is disclosed which includes an internal combustion engine and a cab that includes a firewall disposed between the interior of the cab and the engine. The firewall may include a barrier core layer disposed between a first insulation layer and a second insulation layer. The first insulation layer may be disposed between the barrier core layer and a facing layer. The second insulation layer may be disposed between the barrier core layer and a backing layer.

In yet another aspect, a method of providing sound insulation for a cab of a machine is disclosed. The cab may include a firewall. The method may include providing a sound insulation structure that may include a barrier core layer disposed between a first insulation layer and a second insulation layer. The first insulation layer may be disposed between the barrier core layer and a facing layer. The second insulation layer may be disposed between the barrier core layer and a backing layer. The method may further include coupling the sound insulation structure to the firewall of the machine.

In any one or more of the embodiments described above, the barrier core layer may be a polymeric layer. In a further refinement of this concept, the barrier core layer may include polyethylene. In yet a further refinement of this concept, the barrier core layer may include rubberized polyethylene. In still yet another refinement of this concept, the barrier core layer may be rubberized polyethylene that is free of bitumen.

In any one or more of the embodiments described above, the barrier core layer may have a surface density ranging from about 3 to about 7 kg/m². In a further refinement of this concept, the barrier core layer may have a surface density of about 5 kg/m².

In any one or more of the embodiments described above, the barrier core layer may have a tensile strength of at least 0.4 MPa.

In any one or more of the embodiments described above, the first and second insulation layers may include fiberglass. In a further refinement of this concept, the first insulation layer may be sandwiched between a first pair of scrim layers and the second insulation layer may be sandwiched between a second pair of scrim layers.

In any one or more of the embodiments described above, the facing layer and the backing layer may include non-woven cellulose fibers.

In any one or more of the embodiments described above, the first and second insulation layers may have first and second thicknesses that are at least substantially equal. Further, the barrier core layer may have a barrier core thickness. A ratio of the first or second thicknesses to the barrier core thickness may range from about 3:1 to about 7:1. In a further refinement of this concept, the ratio is about 5:1.

### BRIEF DESCRIPTION OF THE DRAWINGS

FIG. 1 is a side plan view of an articulated truck having a cab that may be equipped with the sound insulation structures disclosed herein.

FIG. 2 is a schematic diagram of an engine and emission control systems that include exhaust gas recirculation (EGR) a diesel particulate filter (DPF) and a selective catalytic reduction (SCR) system.

FIG. 3 is a sectional view of a sound insulation structure made in accordance with this disclosure.

### DETAILED DESCRIPTION OF THE PRESENTLY PREFERRED EMBODIMENTS

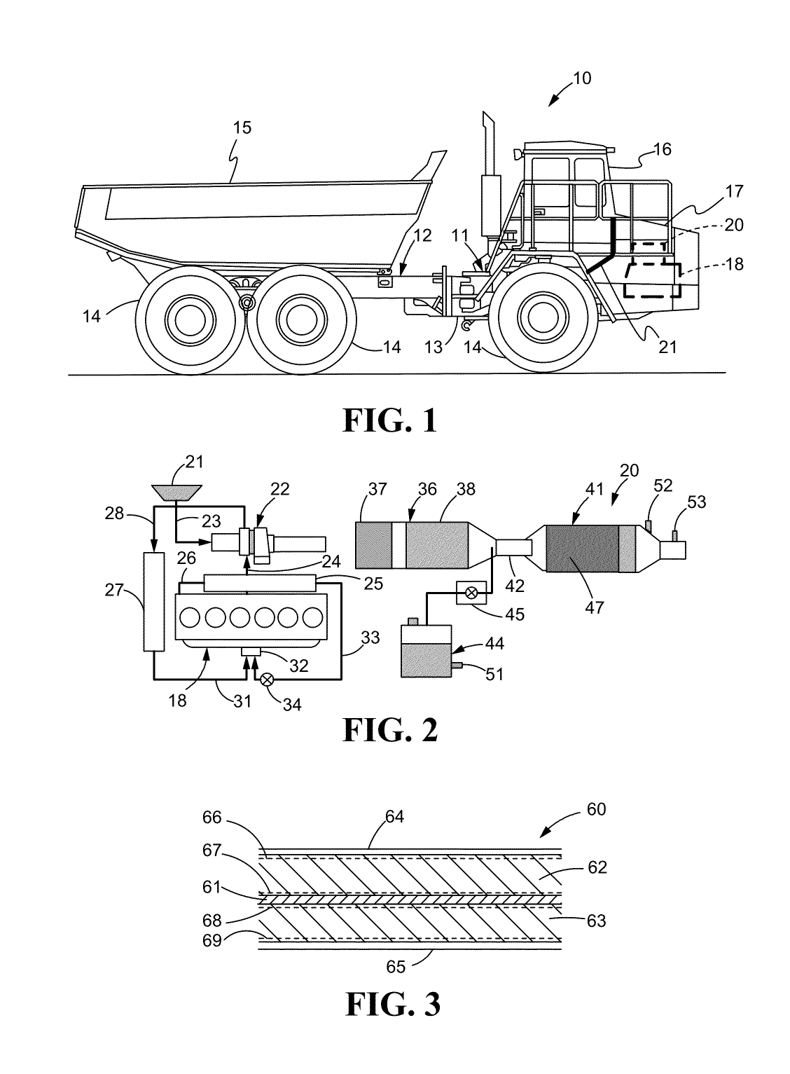

FIG. 1 illustrates an articulated machine 10 having a front frame 11 coupled to a rear frame 12 at an articulated joint 13. The machine 10 may include a plurality of ground engaging devices 14, some of which are disposed below the dump body 15 and some of which is disposed below the cab 16 and engine compartment 17. The engine compartment 17 houses an internal combustion engine shown schematically at 18 and that may be equipped with an emission control system shown schematically at 20 and described in greater detail below in connection with FIG. 2. A firewall 21 may be disposed between the cab 16 and the engine 18/emission control system 20. In addition to protecting the operator of the truck 10 from an engine fire, the firewall 21 may also be used for sound insulation as certain emission control systems 20 have been known to increase noise levels of various internal combustion engines 18.

For example, an emission control system 20 for an internal combustion engine 18 is shown in FIG. 2. The engine 18 may be a diesel engine. The system 20 and engine 18 may include an air filter 21 coupled to a variable geometry turbo charger (VGT) 22 via the inlet line 23. The VGT 22 may include another inlet line 24 that extends from an EGR cooler 25. The EGR cooler 25 may be coupled to the exhaust outlet 26 of the engine 18. The VGT 22 may pump some of the air that passes through the filter 21 and inlet 23 to the air cooler 27 via the line 28. Air may pass through the cooler 27 through the line 31 to a manifold 32 of the engine 18. Further, some of the exhaust exiting the engine 18 through the outlet 26 may pass through the EGR cooler 25 and through the line 33 before passing through an EGR control valve 34 and before entering the manifold 32. Thus, at least some of the exhaust from the engine 18 may be recirculated to the engine 18, which reduces the oxygen content and lowers the combustion temperature, which results in a reduction in NOₓ formation. A remainder of the exhaust may pass through the VGT 22 before passing through a first housing 36 which may include a diesel oxidation catalyst (DOC) 37 and a diesel particulate filter (DPF) 38. The first housing 36 may be connected to a second housing 41 by a passageway 42. The passageway 42 may provide a convenient place to inject a diesel emission fluid (DEF) such as urea, from a reservoir 44. DEF is pumped from the reservoir 44 through a control valve 45 before entering the passageway 42. The housing 41 may include an SCR catalyst 47. A level sensor 51 alerts the operator or the controller when the reservoir 44 is low on DEF. A temperature sensor is shown at 52 and a NOₓ sensor is shown at 53.

It is known that the system 20 shown in FIG. 2 can substantially increase the noise output associated with the engine 18 and emission control system 20. To alleviate the problem of increased noise and the associated help risks to the operator, an improved sound insulation structure 60 is disclosed in FIG. 3, which may be coupled to or connected to the heat shield 21 shown in FIG. 1. Returning to FIG. 3, the sound insulation structure 60 may include a barrier core layer 61 disposed between a first insulation layer 62 and a second insulation layer 63. The first insulation layer 62 may be disposed between the barrier core layer 61 and a facing layer 64. The second insulation layer 63 may be disposed between the barrier core layer 61 and a backing layer 65. Further, one or both of the insulation layers 62, 63 may be sandwiched between scrim layers shown at 66, 67, 68, 69.

The barrier core layer 61 may be polymeric. By way of example, the barrier core layer 61 may be polyethylene, rubberized polyethylene or other suitable polymers that will be apparent to those skilled in the art. Further, the barrier core layer 61 may be rubberized polyethylene that is free of bitumen. Through a suitably detailed research and development program, it has been found that providing a barrier core layer 61 disposed between two insulation layers provides a superior sound insulation structure 60. While one embodiment includes the use of bitumen-free rubberized polyethylene for the barrier core layer 61, other polymers and synthetic rubbers may be used. The surface density of the barrier core layer 61 may range from about 3 to about 7 kg/m². In one aspect, the surface density of the barrier core layer 61 may be about 5 kg/m². Tensile strength of the barrier core layer 61 may also be a relevant property. In one aspect, the barrier core layer 61 may have a tensile strength of at least 0.4 MPa, as measured using the ASTM D412 standard.

The first and second insulation layers 62, 63 may be fabricated from fiberglass. Insulating materials other than fiberglass may be used, as will be apparent to those skilled in the art. The fiberglass used for the insulating layers 62, 63 may include fibers having diameters ranging from about 4 to about 6 microns. In one aspect, the average fiber diameter for the insulation layer 62, 63 may be about 5 microns. Fiberglass layers typically include a binder and the binder content for the insulation layers 62, 63 may range from about 3 to about 6% with one exemplary embodiment being about 4.5%. If scrim is utilized, the scrim may be fabricated from a spin-bonded polyamide, such as a Nylon®. Both the facing layer 64 and backing layer 65 may be fabricated from cellulose fibers, such as non-woven cellulose fibers. The cellulose fibers may be bonded to the insulation layers 62, 63 using any of a variety of adhesives or relying upon the binder content of the insulation layers 62, 63, as will be apparent to those skilled in the art. The disclosed sound insulation structure 60 is also fire resistant.

The thicknesses of the various layers 61, 62, 63 may vary. In one exemplary embodiment the barrier core layer has a thickness of about 2 5 mm while the insulation layer 62, 63 has thicknesses of about 12.5 mm. Obviously, these thickness can vary greatly, depending upon the particular application and noise levels. The ratios of the thickness of the insulation layers 62, 63 to the thickness of the barrier core layer 61 may range from about 3:1 to about 7:1 and, in the non-limiting example described above, the ratio may be about 5:1.

### INDUSTRIAL APPLICABILITY

An improved sound insulation structure for use in protecting operators against increased noise levels that may be caused by emission control systems designed to meet the Tier 4 Final (T4) and the Tier 4 Interim (T4i) emission standards. The disclosed sound insulation structure may be applied to the firewall disposed between the cab of a vehicle, machine or piece of equipment and the internal combustion engine/emission control system. The disclosed sound insulation structure is also fire resistant. Thus, not only will the firewall protect the operator against engine fires, the firewall will also protect the operator against excessive noise levels.

One disclosed sound insulation structure includes a barrier core layer disposed between a pair of insulation layers, which may be fiberglass, which, in turn, are each disposed between the barrier core layer and either a facing layer or a backing layer. Thus, the laminate structure may include backing layer, an insulation layer, a barrier core layer, an insulation layer and a facing layer. The insulation layers may or may not be sandwiched between scrim layers. The sound insulation structure may be formed integrally with the firewall or may be attached to the firewall in a separate procedure. Thus, a disclosed method of improving the noise insulation of a cab associated with an internal combustion engine with a sophisticated emission control system may include installing the heat shield equipped with the disclosed sounds insulation structure or retrofitting an existing heat shield with the disclosed sound insulation structure.

What is claimed:

1. A sound insulation structure comprising:
a barrier core layer disposed between a first insulation layer and a second insulation layer;
the first insulation layer disposed between the barrier core layer and a facing layer;
the second insulation layer disposed between the barrier core layer and a backing layer.

2. The sound insulation structure of claim 1 wherein the barrier core layer is a polymeric layer.

3. The sound insulation structure of claim 1 wherein the barrier core layer includes polyethylene.

4. The sound insulation structure of claim 1 wherein the barrier core layer includes rubberized polyethylene.

5. The sound insulation structure of claim 4 wherein the barrier core layer is free of bitumen.

6. The sound insulation structure of claim 1 wherein the barrier core layer has a surface density ranging from about 3 to about 7 kg/m².

7. The sound insulation structure of claim 1 wherein the sound insulation structure is fire resistant.

8. The sound insulation structure of claim 1 wherein the barrier core layer has a tensile strength of at least 0.4 MPa.

9. The sound insulation structure of claim 1 wherein the first and second insulation layers include fiberglass.

10. The sound insulation structure of claim 9 wherein the first insulation layer is sandwiched between a pair of first scrim layers and the second insulation layer is sandwiched between a pair of second scrim layers.

11. The sound insulation structure of claim 1 wherein the facing layer and the backing layer include non-woven cellulose fibers.

12. The sound insulation structure of claim 1 wherein the first and second insulation layers have first and second thicknesses that are at least substantially equal and the barrier core layer has a barrier core thickness, and a ratio of the first or second thicknesses to the barrier core thickness ranges from about 3:1 to about 7:1.

13. The sound insulation structure of claim 12 wherein the ratio is about 5:1.

14. A machine comprising:
an internal combustion engine;
a cab including a firewall;
the firewall including a barrier core layer disposed between a first insulation layer and a second insulation layer, the first insulation layer disposed between the barrier core layer and a facing layer, the second insulation layer disposed between the barrier core layer and a backing layer.

15. The machine of claim 14 wherein the barrier core layer is a polymeric layer.

16. The machine of claim 14 wherein the barrier core layer includes polyethylene.

17. The machine of claim 14 wherein the barrier core layer has a surface density ranging from about 3 to about 7 kg/m².

18. The machine of claim 14 wherein the barrier core layer has a tensile strength of at least 0.4 MPa.

19. The machine of claim 14 wherein the first and second insulation layers include fiberglass and wherein the facing layer and the backing layer include non-woven cellulose fibers.

20. A method of providing sound insulation and fire resistance for a cab of a machine, the cab including a firewall, the method comprising:
providing a sound insulation structure including a bather core layer disposed between a first insulation layer and a second insulation layer, the first insulation layer disposed between the barrier core layer and a facing layer, the second insulation layer disposed between the barrier core layer and a backing layer; and
coupling the sound insulation structure to the firewall of the machine.
